(19) United States
(12) Patent Application Publication
(10) Pub. No.: US 2022/0333419 A1
(43) Pub. Date: Oct. 20, 2022

(54) SLIDING DOOR ASSEMBLY

(71) Applicant: Yair ASLAN, Jersualem (IL)

(72) Inventor: Yair ASLAN, Jersualem (IL)

(21) Appl. No.: 17/721,717

(22) Filed: Apr. 15, 2022

Related U.S. Application Data
(60) Provisional application No. 63/176,385, filed on Apr. 19, 2021.

(51) Int. Cl. E05D 15/06

(52) U.S. Cl. CPC E05D 15/0608; E05D 15/063; E05D 15/0652; E05D 15/0665; E05D 15/0686; E05F 15/635

(57) ABSTRACT

This invention provides sliding door enclosure assemblies for a framework structure, which uniquely enables equal lateral displacement of sliding doors, with the minimal engagement of a single door alone. More specifically, the sliding door enclosure assemblies of this invention comprise paired rotatable sliding doors, paired rotatable leaders, paired rotating conveyors, which conveyors are advanced by the paired rotatable leaders, guides which further comprise attachment regions to attach the paired rotatable sliding doors to the paired rotating conveyors and at least one interlocking rotatable movement regulator set of two elements, which rotate in equal and opposing directions, so that paired rotatable leaders operationally connected thereby promote lateral displacement of operationally connected rotatable sliding doors about the framework structure.

### CROSS-REFERENCE TO RELATED APPLICATIONS

This application claims priority to U.S. Provisional Application No. 63/176,385, filed Apr. 19, 2021, which is incorporated by reference in its entirety.

### BACKGROUND

### Field

Sliding door enclosures are a known aesthetic option to cordon off any number of enclosures, including wardrobes, sheds, cabinets and closets, to name a few.

### Description of Related Art

Pocket doors are one option for sliding door enclosures. Pocket doors are doors that slide into and out of a hollow cavity, or pocket, in a framework of the enclosure structure. In opening the enclosure, the closed pocket door is slid into and disappears inside a space or pocket in the wall of the structure. To close, the pocket door is slid from its hidden (open-door) position within the pocket.

Conventional pocket doors typically ride on a fixed upper track mounted at the top of an opening into a cabinet or closet. The fixed upper track extends contiguously into the pocket. The pocket door includes a mechanism that engages with and cooperates with the fixed ceiling track, allowing the pocket door to slide in and out of the opening thereupon. One of the desirable features of conventional pocket door systems is that they avoid having a track or sliding mechanism at the floor, such as is required with conventional patio doors. Floor tracks are aesthetically undesirable in an interior setting, for example, at the doorway or egress into a dining room, library, etc. More importantly, however, floor tracks that are readily mounted upon a floor are likely to cause tripping and injury resulting therefore. Other versions have included floor tracks, nonetheless the fixed tracks must absorb any forces exerted by the weight of the door and by the opening and closing forces exerted by a hand of a user or by an electromechanical driving means adapted to automatically slide doors between open and closed positions. The roller mechanisms and fixed tracks are known to squeak, creak, grind, and/or fall off of the track.

Still further limitations result from the limitation imposed by the pocket size as to how much of the interior space is exposed for viewing, when the pocket doors are opened.

There remains a need for a sliding door enclosure mechanism that enables full view of the enclosed contents, in an aesthetically pleasing manner that is not subject to the breakage, noise and other limitations of existing pocket door enclosure systems.

### BRIEF SUMMARY

This invention provides a sliding door enclosure assembly for a framework structure, which uniquely enables equal lateral displacement of sliding doors, with the minimal engagement of a single door alone. In some embodiments, according to this aspect, engagement of a handle on a first door results in equal and opposite lateral displacement in a second, proximally located door, to more fully expose the contents encased by the assembly.

In some embodiments, the sliding door assemblies of this invention uniquely provide a sturdy yet simple mechanism, utilizing reciprocating interlocking elements to coordinate the lateral displacement of operationally connected doors, in a quiet, sturdy construction, which lends itself to practical and stylish application.

In one embodiment, this invention provides a sliding door enclosure assembly for a framework structure, comprising paired rotatable sliding doors, paired rotatable leaders and paired rotating conveyors, which conveyors are advanced by the paired rotatable leaders, guides which further comprise attachment regions to attach said paired rotatable sliding doors to said paired rotating conveyors and at least one interlocking rotatable movement regulator set of two elements, wherein each of said two elements is operationally connected to one of said paired rotatable leaders and is positioned at a height that is different from the height of said paired rotatable leaders, and in sufficient proximity to enable interlocking of said two elements, wherein lateral displacement of a first of said paired rotatable sliding doors facilitates coordinated lateral displacement of a second of said paired rotatable sliding doors about said framework structure.

In some embodiments, the term “sliding door” refers, inter alia, to an enclosing element, which may be comprised of multiple panels that coordinately move and optionally pack or fold, to result in a more compact profile. In some embodiments, the term “sliding door” can be of a minimum of two panels, or in some embodiments, any number of panels, that can be laterally displaced in accordance with the description provided herein.

The term “framework structure” refers, inter alia, to a structure being bounded at least partially, by a frame supporting or accommodating the sliding door enclosure assemblies of this invention, that define and found the area being enclosed thereby.

The term “rotatable leaders” refers, inter alia, to a structure that is capable of rotated movement, and enables movement of rotating conveyors about a defined path. In some embodiments, a rotatable leader may be any rounded structure that can be appropriately affixed to a top and bottom of a sliding door assembly of this invention, wherein the leader is affixed in a convenient meant that still enables rotated movement of the leader and facilitating advancement of a conveyor operationally connected with the rotatable leader.

The term “rotating conveyor” refers, inter alia, to any structure that can be rotated about a defined path enclosing a framework structure, to which a panel or components forming a “sliding door” or embodied enclosing structure/material can be operationally connected so that the “conveyor” participates in mediating lateral displacement of the door/panel/enclosing structural component about the framework structure to either partially or fully expose same (when opening the enclosing assembly) or partially or fully obscure same (when closing the enclosing assembly). The term “rotating conveyor” may be exemplified, in a non-limiting manner, as a belt like structure, or band-like structure, which in some aspects provides guidance as to the use of a material that may, in some embodiments be of strong, non-brittle material so that is may well be rotated about an axis when being conveyed along the path defined in part by the rotatable leader, however, the term should be understood to be illustrative and in no way limiting the width, height or depth of the structure that can serve as the rotating conveyor. It is to be understood that the rotating conveyor may be of any dimension or material that can accommodate the envisioned purpose of both providing a means to operationally connect the elements of the “sliding doors” as herein described in any embodied description provided herein and to be conveyed along a defined path to enable lateral displacement of same, including being rotated about a “rotating conveyor” as part of the defined path.

The sliding door assemblies of this invention promote in some aspects coordinated lateral movement of “sliding doors” as herein described in any embodiment as provided herein, whereby regulated lateral displacement is realized by creating a series of interlocking rotatable elements, that coordinate rotational movement of a first rotatable element to be in an equal and opposite manner to rotational movement in a second rotatable element, which together form the “interlocking rotatable movement regulator set(s)” as herein described.

In some aspects the first (or at least one) rotatable element of an interlocking rotatable movement regulator set may be operationally connected to a rotating conveyor which rotationally moves about an area that is separate form the second rotatable element of the interlocking rotatable movement regulator set, which in turn, is operationally connected to a separate rotating conveyor, for example, as depicted in FIG. 1 as further described hereinunder. According to this aspect, and in some embodiments, the rotating conveyors may be moved about a defined pathway that effectively spans half the width of the area to be enclosed by the assembly.

In some aspects the first (or at least one) rotatable element of an interlocking rotatable movement regulator set may be operationally connected to a rotating conveyor which rotationally moves about an area that follows a similar defined path to that the conveyor operationally connected to the second rotatable element of the interlocking rotatable movement regulator set, for example, as depicted in FIG. 4 as further described hereinunder. According to this aspect, and in some embodiments, the rotating conveyors may be moved about a defined pathway that effectively spans most of the area to be enclosed by the assembly, whereby a first defined path is more internally located than a second defined path for movement of each respective (first and second) conveyor.

In other aspects, the first (or at least one) rotatable element of an interlocking rotatable movement regulator set may be operationally connected to second separate rotating conveyors, each of which independently regulates rotation about the rotatable leaders, for example, as depicted in FIG. 6, whereby additional components of the rotatable leaders move an additional conveyor about a defined path, to enable lateral displacement of the sliding doors operationally connected thereby.

While various embodiments have been presented herein, it will be appreciated that the invention may be implemented in any number of ways, including any desired defined pathway to enclose a structure, for example, by enclosing oval or circular structures, whereby the rotatable leaders may be positioned at defined positions about the circumference of the framework structure to be enclosed, as opposed to, for example the positioning proximal to corners or other edges of more rectangular, square or other angled edge-encasing structures, and the skilled artisan will appreciate the full application options available with the unique elements of the assemblies of this invention.

In some embodiments, each element of said interlocking rotatable movement regulator set of two elements is positioned at a height that is above that of the height of paired rotatable leaders operationally connected thereto. In some embodiments the interlocking rotatable movement regulator set of two elements has a shape approximating an interlocking gears type structure. It will be appreciated that the interlocking rotatable movement regulator set may comprise more than two elements but can in fact comprise any variation of elements that promote coordinated opposing rotation.

In other aspects, it will be understood that any shape or structure that promotes coordinated and opposition rotation may be implemented in the preparation and implementation of the interlocking rotatable movement regulator set, and the interlocking gears is one non-limiting example of such an element.

In some embodiments, the sliding door enclosure assembly is rectangular in shape and lateral displacement includes movement of said paired rotatable sliding doors to accommodate 90 degree turns about an axis in said framework structure.

In some embodiments, the paired rotatable leaders comprise a region which is ridged or grooved, which region engages and facilitates advancement of said paired rotating conveyors.

In some embodiments, the first of said paired rotatable leaders moves in a clockwise direction, a second of said paired rotatable leaders moves in a counter-clockwise direction. In some embodiments, the top surface and bottom surface of said framework structure comprise:
a) paired rotatable leaders;
b) paired rotating conveyors;
c) guides which further comprise attachment regions to attach said paired rotatable sliding doors to said paired rotating conveyors located on said top and bottom surfaces; and
d) at least one interlocking rotatable movement regulator set of two elements, on each of said top and bottom surfaces;
   wherein elements (a), (b), (c) and (d) are coordinately positioned on said top and bottom surface such that lateral displacement of said paired rotatable sliding doors is coordinately accomplished.

In some embodiments, this invention provides a sliding door enclosure assembly for a framework structure, comprising:
paired rotatable sliding doors;
paired rotatable leaders;
paired rotating conveyors, which conveyors are advanced by the paired rotatable leaders;
guides which further comprise attachment regions to attach said paired rotatable sliding doors to said paired rotating conveyors;
at least one rotatable movement regulator set of two elements, wherein each of said two elements is operationally connected to one of said paired rotatable leaders and conveyors and is positioned to rotate opposingly and coordinatedly, such that rotation of a first element in a first direction is coordinated with opposing rotation of said first element such that said conveyors operationally connected thereto are simultaneously, coordinately and opposingly advanced;
   whereby lateral displacement of a first of said paired rotatable sliding doors facilitates coordinated lateral displacement of a second of said paired rotatable sliding doors about said framework structure.

According to this aspect and in some embodiments, when a first element of said rotatable movement regulator set of two elements moves in a clockwise direction, a second element of said rotatable movement regulator set of two elements moves in a counter-clockwise direction and in another embodiment, according to this aspect, when a first of said paired rotatable leaders moves in a clockwise direction, a second of said paired rotatable leaders moves in a counter-clockwise direction.

In some embodiments, this invention provides a sliding door enclosure assembly for a framework structure, comprising:
paired rotatable sliding doors;
paired rotatable leaders;
paired rotating conveyors, which conveyors are advanced by the paired rotatable leaders;
guides which further comprise attachment regions to operationally connect said paired rotatable sliding doors to said paired rotating conveyors;
an interlocking rotatable movement regulator set of two elements, wherein each of said two regulator elements:
   is in sufficient proximity to enable interlocking of said two elements; and
   is operationally connected to a second rotatable leader, which second rotatable leader is further operationally connected to one of said paired rotating conveyors;
      wherein lateral displacement of a first of said paired rotatable sliding doors facilitates coordinated lateral displacement of a second of said paired rotatable sliding doors about said framework structure.

According to this aspect and in some embodiments, the interlocking rotatable movement regulator elements are positioned at a height that is different from the height of said rotatable leaders.

In some embodiments, the sliding door enclosure assembly as herein described further comprises a stabilizing structure located on a top or bottom surface of said framework structure, which is engaged by said guides.

According to this aspect and in some embodiments, the stabilizing structure is a track and said guides comprise a ridged wheel structure to form a stable rail system.

It will be appreciated that the term “stabilizing structure” may be understood to encompass any structure that promotes lateral displacement of the rotatable sliding doors about the framework structure to stably move about the defined pathway, preventing, in some embodiments, more smooth coordinated movement, and in other embodiments, greater structural integrity to the moving parts of the assemblies of this invention and other advantages will be obvious to the skilled artisan, as well.

In some embodiments, the stabilizing structure may be envisioned as a rail or track, or other grooved or structurally modified element that interacts operationally with the guides as herein described to coordinate the desired movement about the framework structure.

In some embodiments, the sliding door enclosure assembly as herein described further comprises paired rotatable sliding doors, which are fully displaced posteriorly following active lateral displacement of a single rotatable sliding door of said paired rotatable sliding doors.

This invention also provides a closet, wardrobe, shed, cabinet, workstation or a safe comprising or surrounded by the sliding door enclosure assembly as herein described.

It will be appreciated that the implementation of the sliding door enclosure assemblies of this invention should not be limited in any way and can constitute any desired structure or composition to effectively enclose a space, as will be understood by the skilled artisan.

### BRIEF DESCRIPTION OF THE DRAWINGS

Various embodiments of the sliding door enclosure assembly for a framework structure of this invention and elements of same are described herein with reference to the figures wherein:

FIGS. 1A-1C depict top and bottom views, respectively and FIG. 1D depicts a front view of a sliding door enclosure assembly for a framework structure of this invention, where the doors are positioned in closed (FIG. 1A, 1D) and open (FIG. 1B, 1C) orientation.

FIGS. 2A-2D depict rotatable leaders (2-70), which advance the rotating conveyors (2-50). Also shown are the conveyor attachment regions (2-60-1; 2-60-2), which attach the rotatable sliding doors to the conveyors. Also shown are guides (2-60-4) for movable attachment of the rotatable conveyor to a rotatable sliding door. The conveyor attachment regions may be part of a larger structure (2-60) that contains a connecting region (2-60-3) to the guide (2-60-4).

FIGS. 3A-3B depict a different view of an embodied sliding door enclosure assembly, including rotating conveyors (3-50), conveyor attachment regions (3-60-1; 3-60-2) guides (3-60-4) connected via specialized structure (3-60-3) to the attachment regions and further operationally connected to stabilizing structures (3-90-1, 3-90-2). Also shown is an interlocking rotatable movement regulator set (3-80-1,3-80-2), which in this non-limiting embodiment, is further positioned at a height different from the height of paired rotatable leaders (3-80-2).

FIGS. 4A-4G depict a different view of an embodied sliding door enclosure assembly, comprising an alternative to the interlocking rotatable movement regulator set of FIG. 2 with a coordinated opposingly rotatable regulator set of (4-80-1 and 4-80-2), which each in turn coordinates advancement of rotating conveyors (4-50-1 and 4-50-2), each of which rotates around the rotatable movement regulator while operationally attaching to a different “slatted”-type door front (4-10), to convey each door of the assembly via conveyor attachment regions (4-60) and thereby coordinately advance each door so that movement of a first door initiates simultaneous opposing movement of a second door of the assembly.

FIG. 5 depicts a front view of embodied sliding door enclosure assembly, in the open position, whereby the sliding doors are fully displaced posteriorly and therefore the contents in the enclosure are fully exposed.

FIGS. 6A-6C depicts another non-limiting embodied sliding door enclosure assembly of this invention, including rotatable leaders (6-70-1 and 6-70-2) which are operationally connected to the sliding door (6-10), rotating conveyors (6-50), door panel and/or conveyor attachment regions/guides (6-60) operationally connected to a stabilizing structure (6-90). Also shown is an interlocking rotatable movement regulator set (FIG. 6B, 6-80-1,6-80-2), which in this non-limiting embodiment, is further positioned at a height different from the height of second rotatable leaders (not viewed in the figure) which are operationally connected to second rotatable leaders (6-100-1 and 6-100-2, respectively). Figure C is an exploded view that promotes visualization of second rotatable leaders 6-80-3 and 6-80-4.

### DETAILED DESCRIPTION

This invention provides, in some embodiments, an enclosure for a framework structure, which contains sliding doors, which can be rotated about the framework structure to fully expose the contents of the enclosure and further provide a posterior recess for the sliding doors.

This invention provides, in some aspects, for an enclosure for a framework structure, which contains sliding doors, which can be rotated about the framework structure, wherein lateral movement of one of two sliding doors promotes coordinate, reciprocal lateral movement of the second of the two sliding doors.

This invention still further provides a sliding door enclosure assembly for a framework structure, comprising:
paired rotatable sliding doors;
paired rotatable leaders;
paired rotating conveyors, which conveyors are advanced by the paired rotatable leaders;
guides which further comprise attachment regions to attach said paired rotatable sliding doors to said paired rotating conveyors;
at least one interlocking rotatable movement regulator set of two elements, wherein each of said two elements is operationally connected to one of said paired rotatable leaders and is positioned at a height that is different from the height of said paired rotatable leaders, and in sufficient proximity to enable interlocking of said two elements;
   wherein lateral displacement of a first of said paired rotatable sliding doors facilitates coordinated lateral displacement of a second of said paired rotatable sliding doors.

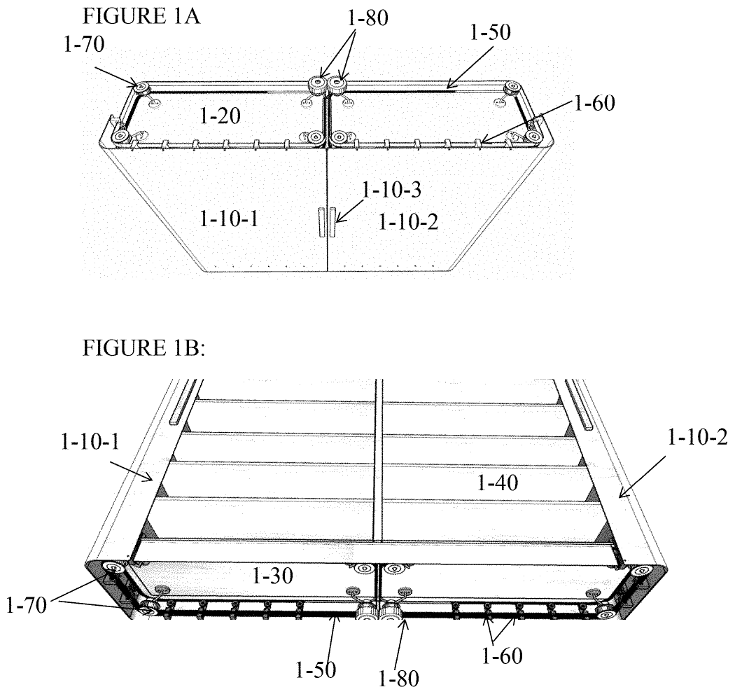

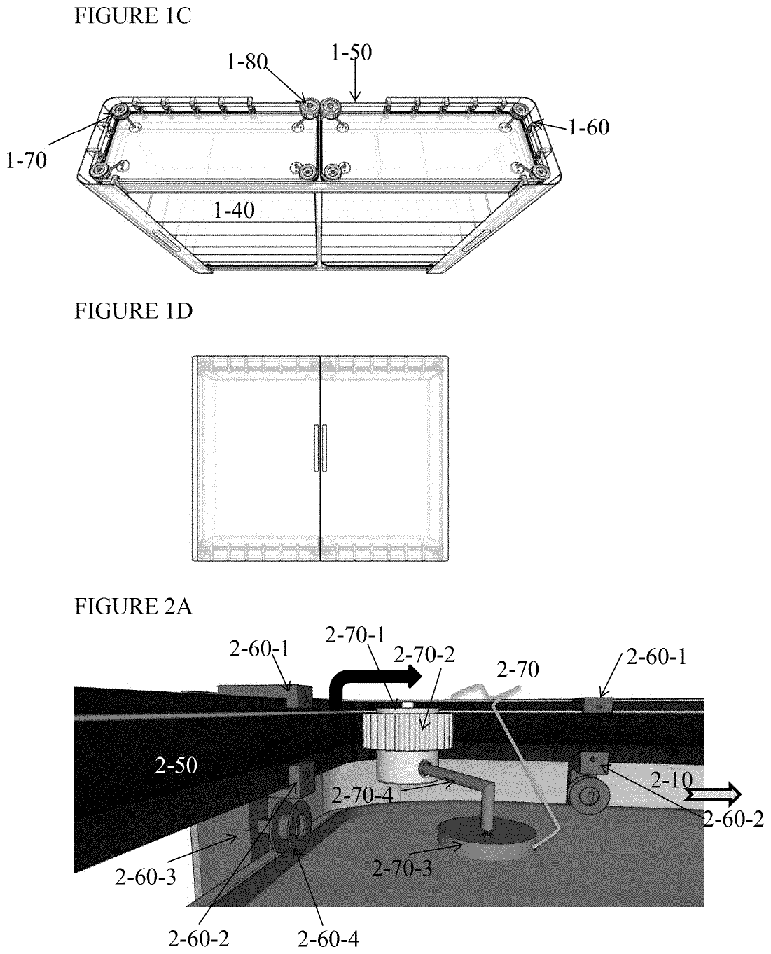

Referring to FIG. 1A a top view of an embodied sliding door enclosure assembly is shown. In this aspect, two sliding doors 1-10-1 and 1-10-2 are shown, and the doors are depicted in the closed position. FIG. 1B similarly depicts a bottom view of the embodied sliding door enclosure assembly of FIG. 1A, with the two sliding doors 1-10-1 and 1-10-2 presented in an open position. In this aspect, the sliding door enclosure assembly is a closet or wardrobe containing shelving 1-40. FIG. 1C further depicts the sliding door enclosure assembly of FIG. 1B, in top view. FIG. 1D depicts a front view of the sliding door enclosure assembly, in the closed position, similar to the view provided in FIG. 1A.

The sliding door enclosure assembly in this aspect depicts shelving but it will be appreciated that the interior being thus enclosed/surrounded by the assembly may comprise other structural elements aside from shelving, such as, for example, rods for handing clothing, equipment whose storage within an enclosed structure is desired, a workstation, a safe, or any element whose enclosure is desired thereby. The invention is thus not to be limited by the placement of elements within the sliding door enclosure assembly of this invention.

The sliding doors 1-10-1 and 1-10-2 may in some aspects have an accessory structure 1-10-3 facilitating lateral movement of each door, such as a handle, depression in the door, or other feature to facilitate lateral movement of the door.

According to the aspect depicted in FIGS. 1A-1D, the sliding door enclosure assembly is rectangular in shape such that the sliding doors are rotated along perpendicularly disposed corners of the framework. It will be appreciated that the sliding door enclosure assemblies of this invention, however, may have an overall geometric structure that is not only rectangular, but instead can be square, circular, oblong, or any shape that is desired, and the framework elements will be built accordingly to accommodate enclosing any desired shape thereby.

According to the aspect depicted in FIGS. 1A-1D, the sliding door enclosure assembly comprises two rotatable sliding doors. This invention provides sliding door enclosure assembly comprising paired rotatable sliding doors. Thus, the sliding door enclosure assemblies of this invention may have two rotatable sliding doors, or in some embodiments, a series of paired doors, such as 4, 6, 8, etc. In some embodiments, the multiple even numbered sets of doors are operably connected in a pairing fashion, such that lateral displacement of a first of said paired rotatable sliding doors, or first half of the multiple operably linked paired doors facilitates coordinated lateral displacement of a second half of multiple operably linked paired doors.

As illustrated in FIGS. 1A-1C, the paired rotatable sliding doors are connected to paired rotating conveyors 1-50, which paired rotating conveyors are advanced by rotation of paired rotatable leaders 1-70. Referring to FIG. 1A, for example, clockwise rotation of a rotatable leader 1-70 would result in movement of the rotating conveyor 1-50. Moreover, guides 1-60 comprise attachment regions, which attach the rotatable sliding doors to the rotating conveyors, such that, as the conveyor is advanced, the sliding door connected thereto is similarly advanced, ultimately displacing the door 1-10-1 from the closed to open position.

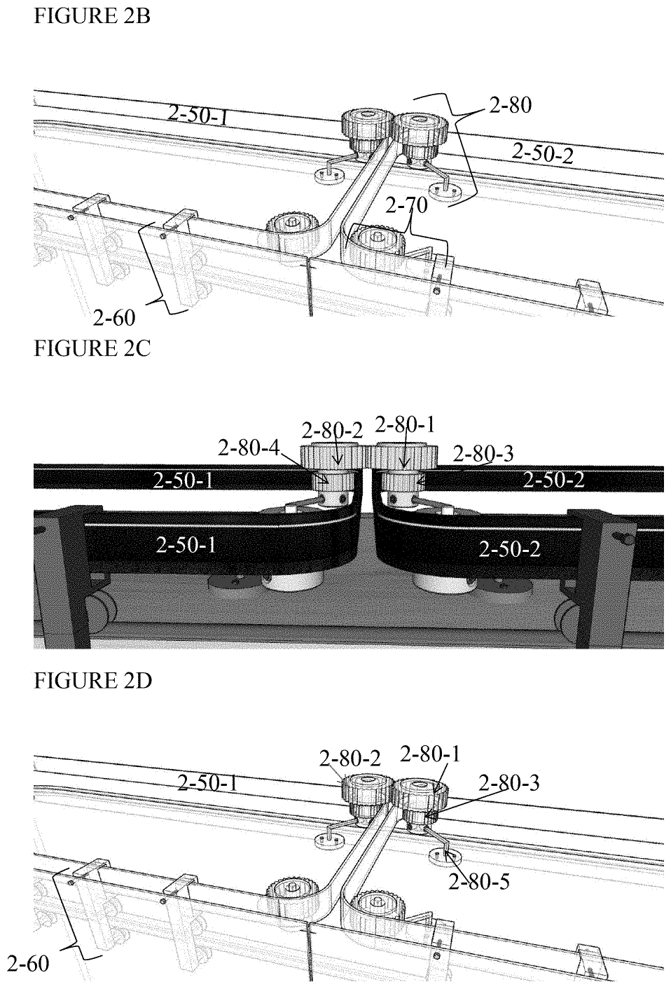

Referring to FIG. 2A, a higher magnification of the rotatable leader 2-70 is shown, whereby embodied elements of same are more readily seen. The rotatable leader is affixed to a surface of the assembly by an attachment region 2-70-4 and a base region 2-70-3, directly affixed to the surface. The rotatable leader engages the conveyor 2-50, and may contain a specialized region 2-70-2, which promotes regulated movement of the conveyor as the leader is rotated.

In some embodiments, the specialized region of the rotatable leader 2-70-2 may be ridged, grooved or otherwise adapted so that slippage, uneven advancement, too rapid advancement, and other undesirable movements during advancement of the conveyor are avoided when the conveyor engages the rotatable leader.

The conveyors (2-50) are operably connected to the rotatable sliding doors by means of conveyor attachment regions (2-60-1; 2-60-2), which may be part of a larger structure (2-60) that contains a connecting region (2-60-3) linking the conveyor attachment regions to the guides (2-60-4), which facilitate movable attachment of the rotatable conveyor to a rotatable sliding door. Thus, as the rotatable leader 2-70 rotates, the conveyor is advanced and the rotatable sliding door operably attached thereto is similarly moved/displaced directionally with the movement of the conveyor.

For example, clockwise rotation of the specialized region 2-70-2 of the rotatable leader 2-70 results in directional incremental movement of the conveyor 2-50 around the “corner” of the assembly (in the direction of the blue arrow depicted in the figure). The rotatable door 2-10 is then further advanced (“around the corner”, in the direction of the red arrow depicted in the figure) in a coordinated controlled fashion.

As is further illustrated in FIG. 1A or 1C as compared to FIG. 1B, reciprocal elements for the rotation mechanism placed at the top of the enclosure are also located on the bottom of the enclosure. Thus, the top surface 1-20 in this embodiment has paired rotatable leaders 1-70 at the corners of the assembly structure and the bottom surface 1-30 has similarly placed paired rotatable leaders 1-70 at the corners of the assembly structure. Guides 1-60 facilitating attachment of the paired rotatable sliding doors to the conveyors located at the top of the structure are also present at the bottom of the structure and similarly facilitate attachment of the same paired rotatable sliding doors to reciprocal conveyors located at the bottom of the structure.

It is to be understood that rotation may be accomplished by providing the elements only on one surface (for example only on a top or bottom surface) of the sliding door enclosure assembly. In some embodiments, providing reciprocal elements on both the top and bottom surfaces of the sliding door enclosure assembly may provide greater stability or durability to the sliding door enclosure assemblies of this invention.

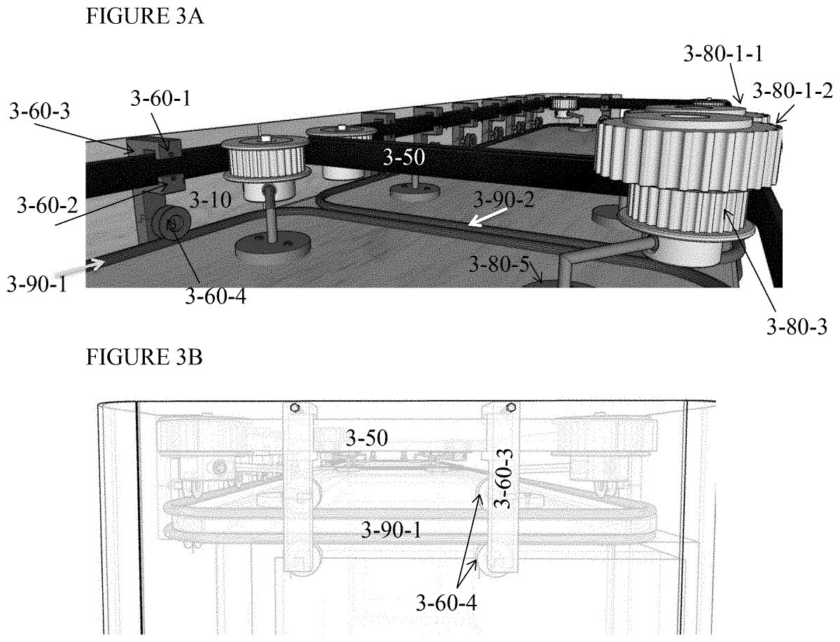

FIGS. 1A-1C further depict an embodied interlocking rotatable movement regulator set of two elements (1-80). The interlocking rotatable movement regulator set of two elements is constructed such that each of said two elements is operationally connected to one of the paired rotatable leaders and is positioned at a height that is different from the height of the paired rotatable leaders, and in sufficient proximity to enable interlocking of the two elements. For example, as depicted further in FIG. 2C, each of the two elements 2-80-1 and 2-80-2 are in sufficient proximity such that ridging in each element aligns with matched riding in the reciprocal element, so that rotation of each element about an axis produces coordinated displacement of the paired conveyors 2-50-1, 2-50-2 attached to each element on a path defined by the rotatable leader 2-80-3 operably connected to the paired interlocking element 2-80-1. Similarly, referring to FIG. 3A, the interlocking rotatable movement regulator set of two elements (3-80-1) is shown, which in some embodiments is further positioned at a height that is different from the height of a paired rotatable leader (3-80-2), such that the interlocking rotatable movement regulator part (3-80-1-1) is in sufficient proximity to its paired interlocking rotatable movement regulator part (3-80-1-2).

The interlocking rotatable movement regulator set of two elements as depicted in FIG. 2C resembles a set of interlocking gears or reciprocal sawtooth structures, whereby upon rotation of a first of the paired element, the second element is reciprocally rotated about an axis and each paired conveyor operably connected thereto incrementally and reciprocally advances. For example, a first conveyor may advance in a clockwise rotation, while the second paired conveyor may advance in a counter-clockwise rotation, creating paired reciprocal rotation pathways.

It will be appreciated that the interlocking rotatable movement regulator set of two elements as described may be of any desired overall shape or contain any appropriate interlocking structure such as, but not limited to, geared, sawtooth, interlocking hooks or hook-eye, ball and socket interlocking structures such as snaps, and any other appropriate interlocking means that can allow for coordinated contact and release as the first interlocking elements is rotated to provide coordinated rotation in the second interlocking element.

In some embodiments, a first interlocking rotatable movement regulator set of two elements is placed on a top surface of the sliding door enclosure assembly and a second interlocking rotatable movement regulator set of two elements is placed on a bottom surface of the sliding door enclosure assembly, at a reciprocal location, so that lateral displacement of the sliding doors is coordinated by the top and bottom located conveyors.

FIGS. 3A-3B depict a different view of an embodied sliding door enclosure assembly, including rotating conveyors (3-50), conveyor attachment regions (3-60-1; 3-60-2) connected to the guides (3-60-4) via connecting region (3-60-3) for movable attachment of the rotatable conveyor to a rotatable sliding door (3-10).

In some embodiments, the guides (3-60-4) may be operationally connected to stabilizing structures (3-90-1, 3-90-2), which may resemble tracks, which further regulate the movement of the guides.

Each interlocking rotatable movement regulator part may comprise an attachment region (3-80-5) to secure the part to the surface of the framework structure.

It will be apparent to the skilled artisan that the components of the sliding door enclosure assembly can be constructed of any number of materials, such as plastics, nylons, metals, composite materials or any related material known in the art.

For example the paired rotatable sliding doors may be comprised of any material appropriate for use, lending itself to rotation about an axis, permitting the desired rotation. Thus, in some embodiments, the paired rotatable sliding doors are comprised of a flexible material that accommodates 90 degree turns about an axis without compromising structural integrity of the rotatable sliding doors. In some embodiments, the paired rotatable sliding doors are comprised of a more rigid material that further contains flexible joint regions that accommodates 90 degree turns about an axis without compromising structural integrity of the rotatable sliding doors. According to this aspect and in some embodiments, such paired rotatable sliding doors may comprise panels made of a hard substance, such as wood, glass, metal or composites of same, seamed by a flexible joint region that accommodates 90 degree turns about an axis of the structure.

In other embodiments, the invention provides for a sliding door enclosure assembly for a framework structure, comprising:
paired rotatable sliding doors;
paired rotatable leaders;
paired rotating conveyors, which conveyors are advanced by the paired rotatable leaders;
guides which further comprise attachment regions to attach said paired rotatable sliding doors to said paired rotating conveyors;
at least one rotatable movement regulator set of two elements, wherein each of said two elements is operationally connected to one of said paired rotatable leaders and conveyors and is positioned to rotate opposingly and coordinatedly, such that rotation of a first element in a first direction is coordinated with opposing rotation of said first element such that said conveyors operationally connected thereto are simultaneously, coordinately and opposingly advanced;
   whereby lateral displacement of a first of said paired rotatable sliding doors facilitates coordinated lateral displacement of a second of said paired rotatable sliding doors about said framework structure.

According to this aspect and in some embodiments, when a first element of said rotatable movement regulator set of two elements moves in a clockwise direction, a second element of said rotatable movement regulator set of two elements moves in a counter-clockwise direction and in another embodiment, according to this aspect, when a first of said paired rotatable leaders moves in a clockwise direction, a second of said paired rotatable leaders moves in a counter-clockwise direction.

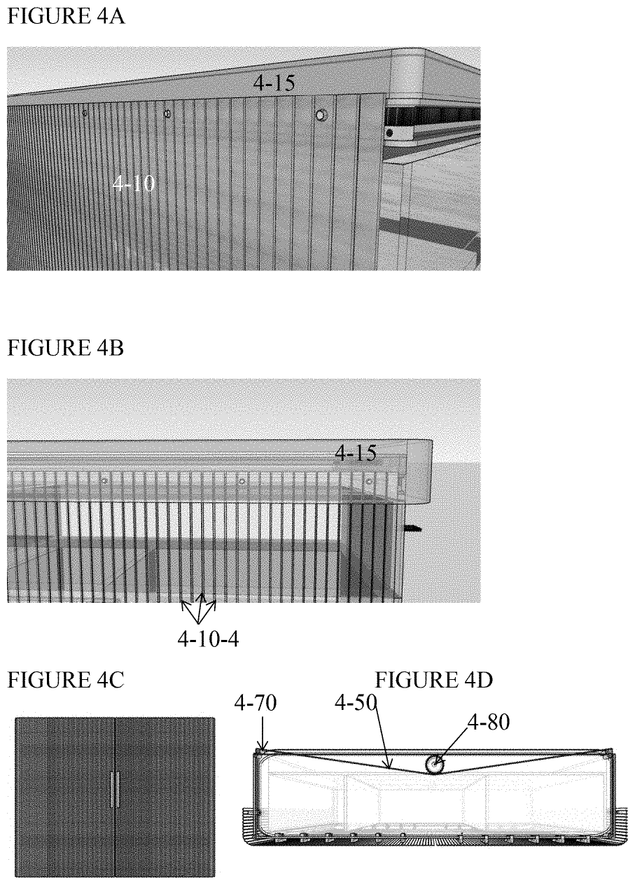

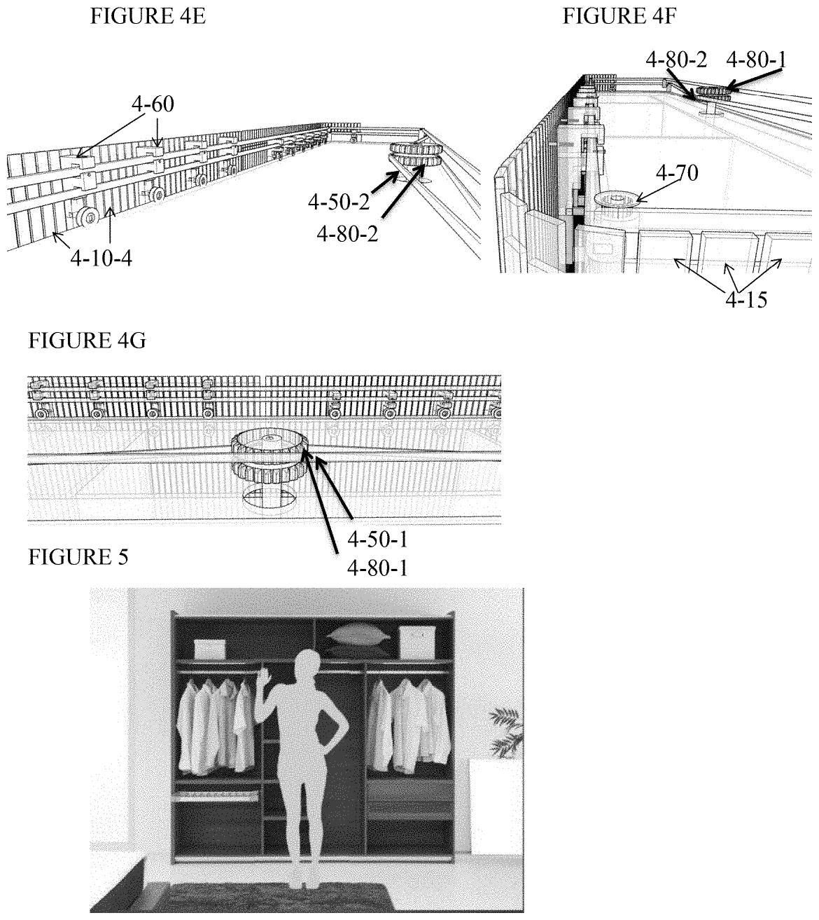

Referring to FIGS. 4A-4G, an embodied sliding door enclosure assembly for a framework structure is depicted. The sliding doors 4-10 may be comprised of slats (4-10), which in turn can be laterally displaced about a framework structure, as is understood from, for example FIG. 4D. According to this aspect and in some embodiments, the paired rotatable leaders, conveyors, guides, and rotatable movement regulator set of two elements, may be obscured from view for example, by including a housing 4-15 on top and bottom of the framework structure.

It will be understand that any embodied sliding door enclosure assembly for a framework structure of this invention may further comprise such additional elements to complete an aesthetic goal of shielding certain components of the enclosure assembly and same is to be considered as part of this invention.

Referring to FIGS. 4D, 4E, 4F and 4G, as noted, the assembly according to this aspect will comprise paired conveyors 4-50-1, 4-50-2, each attached on a path defined by the rotatable leader 4-70, then respectively operably connected to the rotatable movement regulator set of two elements, 4-80.

According to this aspect and in some embodiments, each of said two elements is operationally connected to one of said paired rotatable leaders and conveyors and is positioned to rotate opposingly and coordinatedly, such that rotation of a first element in a first direction is coordinated with opposing rotation of said first element such that said conveyors operationally connected thereto are simultaneously, coordinately and opposingly advanced;

Referring to FIGS. 4E-4G, an alternative to the interlocking rotatable movement regulator set of FIG. 2 is shown, comprising a coordinated opposingly rotatable regulator set of (4-80-1 and 4-80-2), which each in turn coordinates advancement of rotating conveyors (4-50-1 and 4-50-2), each of which rotates around the rotatable movement regulator while operationally attaching to a different doors (4-10), to convey each door of the assembly via conveyor attachment regions (4-60) and thereby coordinately advance each door so that movement of a first door initiates simultaneous opposing movement of a second door of the assembly.

Guides, tracks and other stabilizing structure components, such as shown in FIG. 3 (3-60, 3-90 and the like) can be readily implemented according to this aspect and are to be considered contemplated for this aspect, as well.

In other embodiments, the invention provides for a sliding door enclosure assembly for a framework structure, comprising:
paired rotatable sliding doors;
paired rotatable leaders;
paired rotating conveyors, which conveyors are advanced by the paired rotatable leaders;
guides which further comprise attachment regions to attach said paired rotatable sliding doors to said paired rotating conveyors;
an interlocking rotatable movement regulator set of at least two elements, wherein each of said two regulator elements:
   is in sufficient proximity to enable interlocking of said two elements; and
   is operationally connected to a second rotatable leader, which second rotatable leader is further operationally connected to one of said paired rotating conveyors and is positioned at a height that is different from the height of said rotatable leader and said regulator element;
      wherein lateral displacement of a first of said paired rotatable sliding doors facilitates coordinated lateral displacement of a second of said paired rotatable sliding doors about said framework structure.

According to this aspect, and in some embodiments, each element of the interlocking rotatable movement regulator set of two elements is positioned at an equal height that is above that of the height of placement of said second rotatable leader operationally connected thereto.

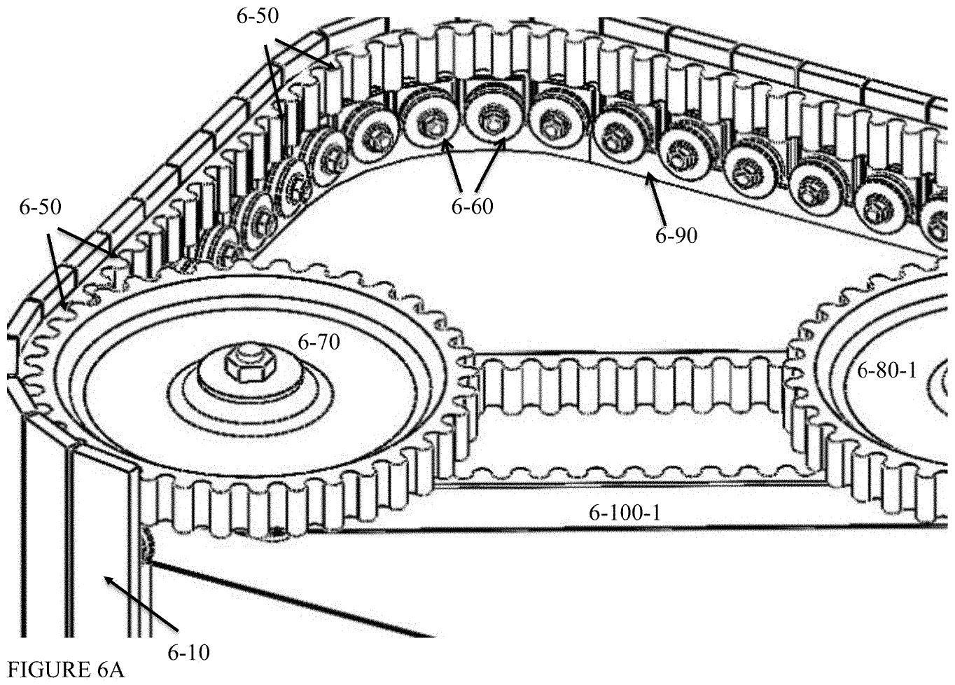

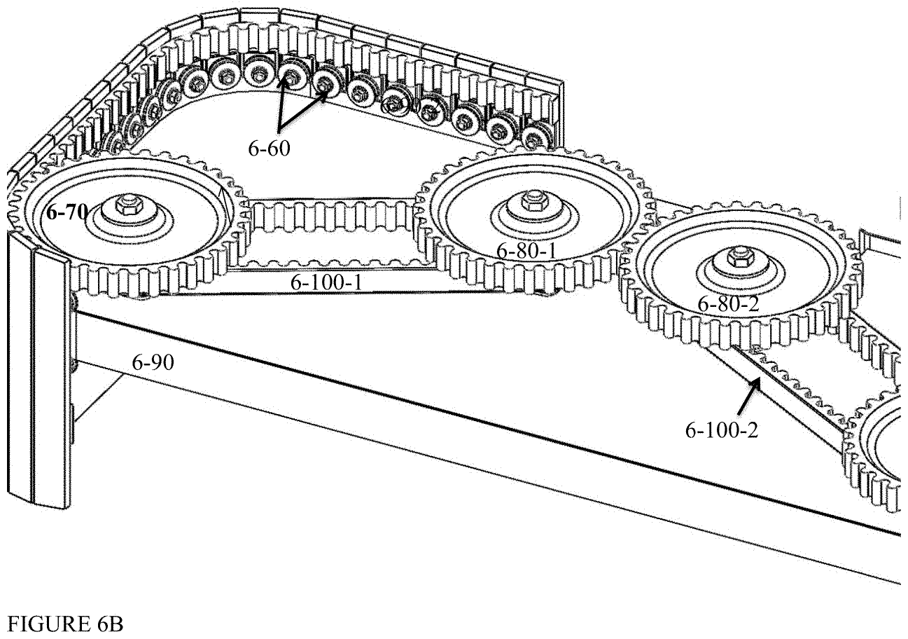

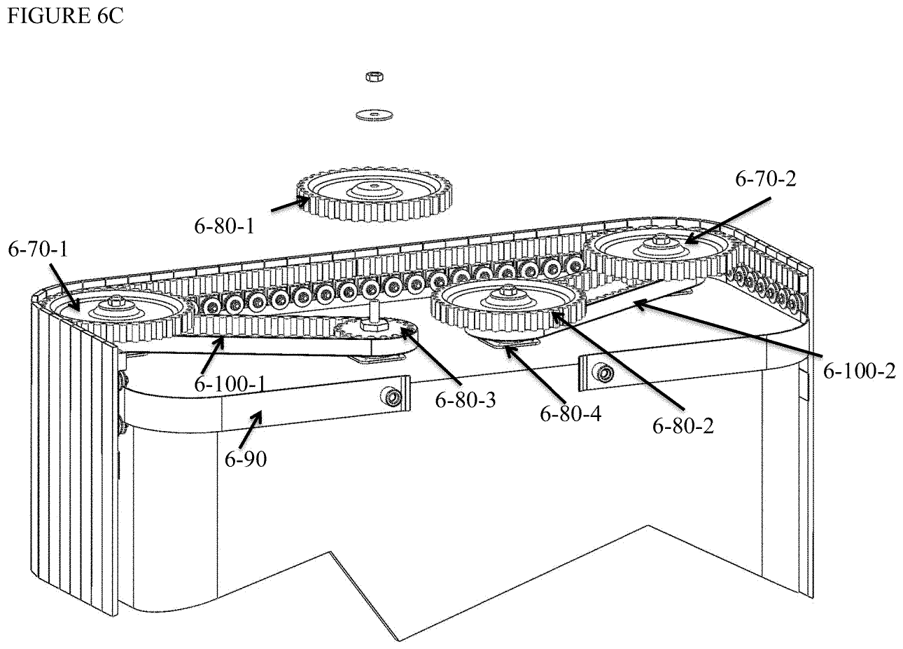

Referring to an embodied aspect, depicted in FIGS. 6A-6C, the interlocking rotatable movement regulator set of two elements may have a shape approximating an interlocking gears type structure (6-80-1 and 6-80-2). These are operationally connected to second rotatable leaders (6-100-1 and 6-100-2).

According to this aspect, there may be a second set of rotatable conveyors that promote coordinate opposing rotation of the leaders (g-70), which in turn interact with the operationally connected first set of conveyors (6-50).

In some aspects, the paired rotatable leaders (6-50) comprise a region which is ridged or grooved, which region engages and facilitates advancement of the rotating conveyors. In some embodiments, the second rotatable leader (6-100) may also comprise a region which is ridged or grooved, which region engages and facilitates advancement of the rotating element of the interlocking element (a component of the interlocking rotatable movement regulator set of at least two elements).

According to these aspects and in some embodiments, the rotating conveyors and/or element components of the interlocking rotatable movement regulator set of at least two elements, comprise a grooved structure that reciprocally interacts with grooved rotatable leaders, although in some embodiments, the leader does not have to be grooved to interact with a grooved conveyor.

In some embodiments, the first element of the interlocking rotatable movement regulator set of at least two elements is moved in a clockwise direction while the second element of the interlocking rotatable movement regulator set of two elements is moved in a counter-clockwise direction and according to this aspect, movement therefore of a first door or its displacement laterally will facilitate equal and opposite lateral displacement of the second door.

In some aspects of this invention, in any of the embodied sliding door enclosure assemblies as herein described, the sliding door enclosure assembly may be rectangular in shape and lateral displacement includes movement of said paired rotatable sliding doors to accommodate 90 degree turns about an axis in said framework structure.

In other aspects of this invention, in any of the embodied sliding door enclosure assemblies as herein described, the top surface and bottom surface of the framework structure comprise:
a) paired rotatable leaders;
b) paired rotating conveyors;
c) guides which further comprise attachment regions to attach said paired rotatable sliding doors to said paired rotating conveyors located on said top and bottom surfaces; and
d) at least one interlocking rotatable movement regulator set of two elements, on each of said top and bottom surfaces;
wherein elements (a), (b), (c) and (d) are coordinately positioned on said top and bottom surface such that lateral displacement of said paired rotatable sliding doors is coordinately accomplished.

In some aspects of this invention, in any of the embodied sliding door enclosure assemblies as herein described, the assembly may further comprise a stabilizing structure located on a top or bottom surface of said framework structure, which is engaged by the guides. According to this aspect and in some embodiments, the stabilizing structure is a track and the guides comprise a ridged wheel structure to form a stable rail system.

In some aspects of this invention, in any of the embodied sliding door enclosure assemblies as herein described, the paired rotatable sliding doors are fully displaced posteriorly following active lateral displacement of a single rotatable sliding door of said paired rotatable sliding doors.

In some embodiments, this invention further provides a closet, wardrobe, shed, cabinet, workstation or a safe comprising or surrounded by a sliding door enclosure assembly as herein described and in accordance with any embodiment described herein, as well.

It will be appreciated that there is no limitation in terms of the materials of which the rotatable sliding doors may be comprised, in that careful design may allow a fully flexible material to be located at discrete key regions to accommodate 90 degree turns about an axis without compromising structural integrity of the rotatable sliding doors.

In some embodiments, the paired rotatable leaders, paired rotating conveyors, guides and interlocking rotatable movement regulator set of two elements may be comprised of any appropriate materials to facilitate the intended function of each element. For example, and in some embodiments, the paired rotatable leaders, guides and interlocking rotatable movement regulator set of two elements may be comprised of any plastic, nylon or related material, as same is easily and cheaply manufactured. In other embodiments, the paired rotatable leaders, guides and interlocking rotatable movement regulator set of two elements may be comprised of a metal or metal alloy, or metal composite structure.

In some embodiments, the paired rotating conveyors may be comprised of a structurally strong but somewhat elastic material, such as a rubber or rubber composite structure, or plastic or nylon belt structure or the like.

It will be appreciated by the skilled artisan that any number of materials may be used to prepare the elements of the sliding door enclosure assembly for a framework structure of this invention and the invention is not in any way to be limited in terms of the materials intended for use in construction of same.

Similarly, any number of methods may be used by the skilled artisan to prepare the elements of the sliding door enclosure assembly for a framework structure of this invention such as cast molding, 3D-printing, and any other known means for assembling the components as herein described and the invention is not in any way to be limited in terms of the methods for use in construction of same.

In some aspects, the invention provides a scalable pocket door system, improved over existing systems in that there is no need for a fixed ceiling track and bottom track and instead the conveyor operably linked to the guides, which in turn may further align with additional stabilizing structures, which resemble tracks, regulate the movement of the guides and the conveyor operably linked thereto, where the elements are fully incorporated and found within the sliding door enclosure assembly itself, and no additional tracks are necessary within the framework structure being enclosed thereby, providing a fully contained system with fully rotatable sliding doors, providing maximum stability of the rotating sliding doors and enhanced visibility of the contents of the enclosed framework structure.

In some embodiments, the guide element specifically engaging the stabilizing structures may be so constructed to provide a rotating, ridged wheels, which flank the stabilizing structure, to approximate the structure of a stable rail system, unlikely to jam or dislodge in any open, closed, or transition positions.

In some embodiments, the presence of reciprocal elements of the sliding door enclosure assembly are located on the top and bottom surfaces of the system, functioning cooperatively, and further stabilizing operation of same.

Referring to FIG. 4, another advantage of the sliding door enclosure assemblies of this invention is the fact that in use of same, the sliding doors may be displaced to the open position, whereby the sliding doors are fully displaced posteriorly and the contents in the framework structure enclosure are fully exposed thereby.

In some aspects, in addition to the full displacement posteriorly of the sliding doors as described hereinabove, the sliding door enclosure assemblies of this invention provide the further advantage that displacement of both doors posteriorly is accomplished in a coordinated fashion manually by lateral movement of only one of the paired rotatable doors.

In some embodiments, the arrangement of the parts of the sliding door enclosure assemblies of this invention allows for simple and far less noisy operation than available pocket door assemblies available to date.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

It will be understood by those skilled in the art that various changes in form and details may be made therein without departing from the spirit and scope of the invention as set forth in the appended claims. Those skilled in the art will recognize or be able to ascertain using no more than routine experimentation, many equivalents to the specific embodiments of the invention described herein. Such equivalents are intended to be encompassed in the scope of the claims.

In the claims articles such as “a,”, “an” and “the” mean one or more than one unless indicated to the contrary or otherwise evident from the context. Claims or descriptions that include “or” or “and/or” between members of a group are considered satisfied if one, more than one, or all of the group members are present in, employed in, or otherwise relevant to a given product or process unless indicated to the contrary or otherwise evident from the context. The invention includes embodiments in which exactly one member of the group is present in, employed in, or otherwise relevant to a given product or process. The invention also includes embodiments in which more than one, or all of the group members are present in, employed in, or otherwise relevant to a given product or process. Furthermore, it is to be understood that the invention provides, in various embodiments, all variations, combinations, and permutations in which one or more limitations, elements, clauses, descriptive terms, etc., from one or more of the listed claims is introduced into another claim dependent on the same base claim unless otherwise indicated or unless it would be evident to one of ordinary skill in the art that a contradiction or inconsistency would arise. Where elements are presented as lists, e.g. in Markush group format or the like, it is to be understood that each subgroup of the elements is also disclosed, and any element(s) can be removed from the group. It should it be understood that, in general, where the invention, or aspects of the invention, is/are referred to as comprising particular elements, features, etc., certain embodiments of the invention or aspects of the invention consist, or consist essentially of, such elements, features, etc. For purposes of simplicity those embodiments have not in every case been specifically set forth in haec verba herein. Certain claims are presented in dependent form for the sake of convenience, but Applicant reserves the right to rewrite any dependent claim in independent format to include the elements or limitations of the independent claim and any other claim(s) on which such claim depends, and such rewritten claim is to be considered equivalent in all respects to the dependent claim in whatever form it is in (either amended or unamended) prior to being rewritten in independent format.

What is claimed is:

1. A sliding door enclosure assembly for a framework structure, comprising:
paired rotatable sliding doors;
paired rotatable leaders;
paired rotating conveyors, which conveyors are advanced by the paired rotatable leaders;
guides which further comprise attachment regions to attach said paired rotatable sliding doors to said paired rotating conveyors;
at least one interlocking rotatable movement regulator set of two elements, wherein each of said two elements is operationally connected to one of said paired rotatable leaders and is positioned at a height that is different from the height of said paired rotatable leaders, and in sufficient proximity to enable interlocking of said two elements;
wherein lateral displacement of a first of said paired rotatable sliding doors facilitates coordinated lateral displacement of a second of said paired rotatable sliding doors about said framework structure.

2. The sliding door enclosure assembly of claim 1, wherein each element of said interlocking rotatable movement regulator set of two elements is positioned at a height that is above that of the height of paired rotatable leaders operationally connected thereto.

3. The sliding door enclosure assembly of claim 1, wherein said interlocking rotatable movement regulator set of two elements has a shape approximating an interlocking gears type structure.

4. The sliding door enclosure assembly of claim 1, wherein said paired rotating conveyors are belt structures or wherein said paired rotatable leaders comprise a region which is ridged or grooved, which region engages and facilitates advancement of said paired rotating conveyors, optionally wherein said paired rotating conveyors comprise a grooved structure that reciprocally interacts with said rotatable leaders.

5. The sliding door enclosure assembly of claim 1, wherein when a first of said paired rotatable leaders moves in a clockwise direction, a second of said paired rotatable leaders moves in a counter-clockwise direction.

6. The sliding door enclosure assembly of claim 1, wherein said sliding door enclosure assembly is rectangular in shape and lateral displacement includes movement of said paired rotatable sliding doors to accommodate 90 degree turns about an axis in said framework structure.

7. The sliding door enclosure assembly of claim 1, wherein a top surface and bottom surface of said framework structure comprise:
a) paired rotatable leaders;
b) paired rotating conveyors;
c) guides which further comprise attachment regions to attach said paired rotatable sliding doors to said paired rotating conveyors located on said top and bottom surfaces; and
d) at least one interlocking rotatable movement regulator set of two elements, on each of said top and bottom surfaces;
wherein elements (a), (b), (c) and (d) are coordinately positioned on said top and bottom surface such that lateral displacement of said paired rotatable sliding doors is coordinately accomplished.

8. The sliding door enclosure assembly of claim 1, further comprising a stabilizing structure located on a top or bottom surface of said framework structure, which is engaged by said guides, optionally, wherein said stabilizing structure is a track and said guides comprise a ridged wheel structure to form a stable rail system.

9. The sliding door enclosure assembly of claim 1, wherein said paired rotatable sliding doors are fully displaced posteriorly following active lateral displacement of a single rotatable sliding door of said paired rotatable sliding doors.

10. A closet, wardrobe, shed, cabinet, workstation or a safe comprising or surrounded by the sliding door enclosure assembly claim 1.

11. A sliding door enclosure assembly for a framework structure, comprising:
paired rotatable sliding doors;
paired rotatable leaders;
paired rotating conveyors, which conveyors are advanced by the paired rotatable leaders;
guides which further comprise attachment regions to attach said paired rotatable sliding doors to said paired rotating conveyors;
at least one rotatable movement regulator set of two elements, wherein each of said two elements is operationally connected to one of said paired rotatable leaders and conveyors and is positioned to rotate opposingly and coordinatedly, such that rotation of a first element in a first direction is coordinated with opposing rotation of said first element such that said conveyors operationally connected thereto are simultaneously, coordinately and opposingly advanced;
whereby lateral displacement of a first of said paired rotatable sliding doors facilitates coordinated lateral displacement of a second of said paired rotatable sliding doors about said framework structure.

12. The sliding door enclosure assembly of claim 11, wherein said rotatable movement regulator set of two elements has a surface that is non-slip to better promote regulated advancement of said conveyors.

13. The sliding door enclosure assembly of claim 11, wherein said paired rotating conveyors are belt structures, or wherein said paired rotating conveyors comprise a grooved structure that reciprocally interacts with said rotatable leaders, or wherein said paired rotatable leaders comprise a region which is ridged or grooved, which region engages and facilitates advancement of said paired rotating conveyors.

14. The sliding door enclosure assembly of claim 11, wherein when a first element of said rotatable movement regulator set of two elements moves in a clockwise direction, a second element of said rotatable movement regulator set of two elements moves in a counter-clockwise direction, or wherein when a first of said paired rotatable leaders moves in a clockwise direction, a second of said paired rotatable leaders moves in a counter-clockwise direction.

15. The sliding door enclosure assembly of claim 11, wherein said sliding door enclosure assembly is rectangular in shape and lateral displacement includes movement of said paired rotatable sliding doors to accommodate 90 degree turns about an axis in said framework structure.

16. The sliding door enclosure assembly of claim 11, wherein a top surface and bottom surface of said framework structure comprise:
e) paired rotatable leaders;
f) paired rotating conveyors;
g) guides which further comprise attachment regions to attach said paired rotatable sliding doors to said paired rotating conveyors located on said top and bottom surfaces; and
h) at least one interlocking rotatable movement regulator set of two elements, on each of said top and bottom surfaces;
wherein elements (a), (b), (c) and (d) are coordinately positioned on said top and bottom surface such that lateral displacement of said paired rotatable sliding doors is coordinately accomplished.

17. The sliding door enclosure assembly of claim 11, further comprising a stabilizing structure located on a top or bottom surface of said framework structure, which is engaged by said guides, optionally, wherein said stabilizing structure is a track and said guides comprise a ridged wheel structure to form a stable rail system.

18. The sliding door enclosure assembly of claim 11, wherein said paired rotatable sliding doors are fully displaced posteriorly following active lateral displacement of a single rotatable sliding door of said paired rotatable sliding doors.

19. A closet, wardrobe, shed, cabinet, workstation or a safe comprising or surrounded by the sliding door enclosure assembly claim 11.

20. A sliding door enclosure assembly for a framework structure, comprising:
paired rotatable sliding doors;
paired rotatable leaders;
paired rotating conveyors, which conveyors are advanced by the paired rotatable leaders;
guides which further comprise attachment regions to attach said paired rotatable sliding doors to said paired rotating conveyors;
an interlocking rotatable movement regulator set of two elements, wherein each of said two regulator elements:
is in sufficient proximity to enable interlocking of said two elements; and
is operationally connected to a second rotatable leader, which second rotatable leader is further operationally connected to one of said paired rotating conveyors and is positioned at a height that is different from the height of said rotatable leader and said regulator element;
wherein lateral displacement of a first of said paired rotatable sliding doors facilitates coordinated lateral displacement of a second of said paired rotatable sliding doors about said framework structure.

21. The sliding door enclosure assembly of claim 20, wherein each element of said interlocking rotatable movement regulator set of two elements is positioned at an equal height that is above that of the height of placement of said second rotatable leader operationally connected thereto.

22. The sliding door enclosure assembly of claim 20, wherein said interlocking rotatable movement regulator set of two elements has a shape approximating an interlocking gears type structure, optionally, wherein said paired rotating conveyors are belt structures, optionally, wherein said paired rotatable leaders comprise a region which is ridged or grooved, which region engages and facilitates advancement of said paired rotating conveyors, optionally, wherein said paired rotating conveyors comprise a grooved structure that reciprocally interacts with said rotatable leaders.

23. The sliding door enclosure assembly of claim 20, wherein when a first element of said interlocking rotatable movement regulator set of two elements is moved in a clockwise direction, a second element of said interlocking rotatable movement regulator set of two elements is moved in a counter-clockwise direction.

24. The sliding door enclosure assembly of claim 20, wherein said sliding door enclosure assembly is rectangular in shape and lateral displacement includes movement of said paired rotatable sliding doors to accommodate 90 degree turns about an axis in said framework structure.

25. The sliding door enclosure assembly of claim 20, wherein a top surface and bottom surface of said framework structure comprise:
i) paired rotatable leaders;
j) paired rotating conveyors;
k) guides which further comprise attachment regions to attach said paired rotatable sliding doors to said paired rotating conveyors located on said top and bottom surfaces; and
l) at least one interlocking rotatable movement regulator set of two elements, on each of said top and bottom surfaces;
wherein elements (a), (b), (c) and (d) are coordinately positioned on said top and bottom surface such that lateral displacement of said paired rotatable sliding doors is coordinately accomplished.

26. The sliding door enclosure assembly of claim 20, further comprising a stabilizing structure located on a top or bottom surface of said framework structure, which is engaged by said guides, optionally, wherein said stabilizing structure is a track and said guides comprise a ridged wheel structure to form a stable rail system.

27. The sliding door enclosure assembly of claim 20, wherein said paired rotatable sliding doors are fully displaced posteriorly following active lateral displacement of a single rotatable sliding door of said paired rotatable sliding doors.

28. A closet, wardrobe, shed, cabinet, workstation or a safe comprising or surrounded by the sliding door enclosure assembly claim 20.
